(19) United States
(12) Patent Application Publication
(10) Pub. No.: US 2009/0202208 A1
(43) Pub. Date: Aug. 13, 2009

(54) AIR BLOWN OPTICAL FIBER UNIT HAVING BEAD ATTACHED ON THE SURFACE

(76) Inventor: Chan-Yong Park, Seoul (KR)

Correspondence Address: STROOCK & STROOCK & LAVAN LLP, 180 MAIDEN LANE, NEW YORK, NY, 10038, US

(21) Appl. No.: 11/720,992

(22) PCT Filed: Dec. 8, 2004
(86) PCT No.: PCT/KR05/02074

§ 371 Date: Jun. 6, 2007

(51) Int. Cl. G02B 6/44

(52) U.S. Cl. 385/100

(57) ABSTRACT

Disclosed is an air blown optical fiber unit having low friction with an installation tube during air blown installation. The air blown optical fiber unit includes at least one optical fiber, a buffer layer surrounding the optical fiber and made of polymer resin, an outer layer surrounding the buffer layer and made of polymer resin, and beads attached on a surface of the outer layer, and the beads have an average diameter of 80 μm to 140 μm and an average roughness of 10 μm or less and a radio (R/r) of a long radius (R) to a short radius (r) is in the range of 1 to 1.5. The optical fiber unit gives less friction with the inner surface of an installation tube during the installation work, so it may be easily installed not only in a linear region but also in a curved region.

### TECHNICAL FIELD

The present invention relates to an air blown optical fiber unit, and more particularly to an air blown optical fiber unit having low friction with an installation tube during air blown installation.

### BACKGROUND ART

For installation of optical fibers, a method of binding or twisting several optical fibers into a cable, and then installing this cable has been mainly used. In this cable installation method, optical fibers much more than required at the point of installation are generally installed in advance with expectation of future demands.

However, since more various kinds of optical fibers are required according to the trend of new communication environments and there have been developed high performance communication systems suitably coping with communication capacity even in restricted optical fiber installation environments, it cannot be considered desirable that a large amount of optical fibers are installed in advance just with expectation of future demands. In particular, in aspect of a user terminal, namely an access network or a premise wiring, a mode of an optical fiber or cable in future cannot be decided at the present point of time. Thus, if a large amount of optical fibers are installed in advance with incurring much expense, there may be a waste of money if a mode of an optical fiber or cable is changed in future.

In order to solve the above problems, a method for installing an optical fiber unit having several optical fiber strands collected therein by air pressure is widely used. This air blown installation method was firstly proposed by British Telecom Co. (see U.S. Pat. No. 4,691,896) in 1980. In this air blown installation method, a polymer installation tube, called a micro tube or duct, having specific constitution and sectional shape is installed at an optical fiber installation spot in advance, and then an air blown optical fiber unit (hereinafter, referred to just as ‘an optical fiber unit’) is inserted into the micro tube or duct as much as required by air pressure. If optical fibers are installed using the above optical fiber installation method, many advantages are ensured, namely easy installation and removal of optical fibers, reduced costs for initial installation, and easy improvement of performance in future.

FIG. 1 is a schematic view showing an optical fiber unit installation device used in the above air blown installation method. Referring to FIG. 1, the installation device successively inserts an optical fiber unit 1 from an optical fiber unit supplier 2 into an installation tube 4 connected to an outlet C of a blowing head 5 by using a driving roller 3 and a pressing means 6, and at the same time blows compressed air toward the outlet C of the blowing head 5 by using the pressing means 6. Then, the compressed air flows at a fast rate toward the outlet C, and accordingly the optical fiber unit 1 introduced into the blowing head 5 is installed in the installation tube 4 by means of a fluid drag force of the compressed air.

In order to ensure desirable installation of the optical fiber unit 1 in the air blown installation method, the fluid drag force of the compressed air should be great.

The fluid drag force F may be expressed as follows.

$${\vec{F}}_{drag} = {PR}_{1} {R}_{2} \frac{d P}{d L} \qquad Equation 1$$

(P: compressed air pressure, R₁: inner diameter of the installation tube, R₂: outer diameter of the optical fiber unit, L: length of the installation tube)

In the Equation 1, the inner diameter R₁ of the installation tube and the outer diameter R₂ of the optical fiber unit are already defined in standards. Thus, in order to maximize the fluid drag force F, it is preferred to form irregularity on the surface of the optical fiber unit for increasing a contact area between the compressed air and the optical fiber unit.

As a scheme for increasing a contact area between the compressed air and the optical fiber unit, glass beads may be attached on the surface of an optical fiber unit to form irregularity thereon, as disclosed in U.S. Pat. No. 5,042,907 and U.S. Pat. No. 5,555,335.

Meanwhile, an installation region of an optical fiber unit generally reaches 500 m to several kilometers, so during the air blown installation, the optical fiber unit is installed with partially contacting with the inner surface of the installation tube, not flying in the center of the installation tube over the entire region.

Thus, in case the optical fiber unit having glass beads attached to its surface is installed by air pressure, friction is generated between the beads and the inner surface of the installation tube.

However, the above patents do not disclose any surface characteristic or shape of the bead, which give essential influences on the friction with the inner surface of the installation tube. Thus, since an optical fiber unit having beads attached on its surface regardless of friction with the inner surface of the installation tube is installed, an installation rate of the optical fiber unit is abruptly reduced in the conventional techniques. In particular, in a curved installation region, friction is increased to frequently interrupt the installation work of an optical fiber unit.

### DISCLOSURE OF INVENTION

### Technical Problem

The present invention is designed in consideration of the above problems, and therefore it is an object of the invention to provide an optical fiber unit having optimized surface characteristic and shape of beads, which may decrease friction between an installation tube and beads attached on the surface of an optical fiber unit during air blown installation to improve air blow installation ability.

### Technical Solution

In order to accomplish the above object, the present invention provides an air blown optical fiber unit, which includes at least one optical fiber; a buffer layer surrounding the optical fiber and made of polymer resin; an outer layer surrounding the buffer layer and made of polymer resin; and beads attached on a surface of the outer layer, wherein the beads have an average diameter of 80 μm to 140 μm and an average roughness of 10 μm or less.

Here, the beads preferably have a spherical shape in which a radio (R/r) of a long radius (R) to a short radius (r) is in the range of 1 to 1.5.

In another aspect of the invention, there is also provided an air blown optical fiber unit, which includes at least one optical fiber; a buffer layer surrounding the optical fiber and made of polymer resin; an outer layer surrounding the buffer layer and made of polymer resin; and spherical beads attached on a surface of the outer layer, wherein the spherical beads have a radio (R/r) of a long radius (R) to a short radius (r) in the range of 1 to 1.5.

In the present invention, the beads are preferably made of glass.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows an optical fiber unit installation device used for air blown installation;

FIG. 2 is a perspective view showing an air blown optical fiber unit according to an embodiment of the present invention;

FIG. 3 is a photograph of beads according to an embodiment of the present invention;

FIG. 4 is an enlarged photograph of the beads of FIG. 3;

FIG. 5 is a photograph of beads attached on a surface of a conventional air blown optical fiber unit; and

FIG. 6 is an enlarged photograph of the beads of FIG. 5.

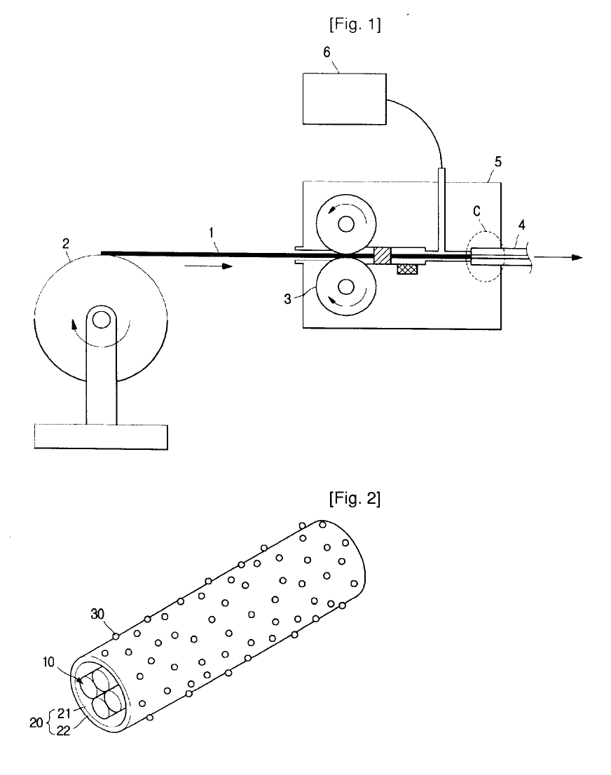

### BEST MODE FOR CARRYING OUT THE INVENTION

The present invention will be described in detail referring to the drawings, the terms used should not be construed as limited to general and dictionary meanings but based on the meanings and concepts of the invention on the basis of the principle that the inventor is allowed to define terms appropriate for the best explanation. Therefore, the description herein the scope of the invention be understood that other and modifications could be made thereto without departing from the spirit and scope of the invention.

FIG. 2 is a perspective view showing an air blown optical fiber unit according to an embodiment of the present invention. Referring to FIG. 2, the optical fiber unit according to the present invention includes at least one optical fiber 10, and a protective layer 20 formed on an outside of the optical fiber 10.

The optical fiber 10 is a single-mode or multi-mode optical fiber having a core layer and a clad layer, made of quartz materials. The optical fiber 10 may have a single core or multiple cores as shown in FIG. 2.

The protective layer 20 is a coating layer surrounding the optical fiber 10 to protect the optical fiber 10 and ensure stiffness. The protective layer 20 may be composed of one kind of coating layer or various kinds of coating layers laminated. Preferably, the protective layer 20 has a dual structure composed of a buffer layer 21 and an outer layer 22. However, the protective layer 20 may have only the buffer layer 21 or additionally have an intermediate layer between the buffer layer 21 and the outer layer 22 in various ways, not limited to the above case.

The buffer layer 21 is a coating layer directly surrounding the optical fiber 10. The buffer layer 21 is made of radiation curable polymer resin that is cured by radiation, and preferably made of radiation curable acrylate.

The outer layer 22 is a coating layer surrounding the buffer layer 21 and to which beads 30 are attached. The outer layer 22 is made of radiation curable polymer resin, similarly to the buffer layer 21, but radiation curable acrylate having higher Young's modulus than the buffer layer 21 is preferably used for protecting the optical fiber 10 against external impacts and keeping stiffness of the optical fiber unit during air blown installation.

The beads 30 are particles attached to the outer layer 22 to increase a fluid drag force of the compressed air during air blown installation. As the beads 30 are protruded higher, a contact area between the compressed air and the optical fiber unit is increased, and accordingly the fluid drag force of the compressed air is improved to ensure easier installation of the optical fiber unit. However, if the beads 30 have great diameter to increase height of the beads 30, it is difficult to control the process of attaching the beads 30 on the surface of the outer layer 22, and also the optical fiber unit has increased weight, resulting in deteriorated installation characteristics. Thus, it is preferred that the beads 30 have an average diameter of 80 μm to 140 μm. More preferably, the beads 30 have an average diameter of 90 μm to 120 μm. The beads 30 are preferably made of glass, but not limitedly.

Meanwhile, during the air blown installation, an optical fiber unit inserted into the installation tube may have deteriorated installation characteristics due to the friction between the beads 30 protruded from its surface and the inner surface of the installation tube. Thus, the beads 30 preferably use glass beads 30 having low frictional coefficient. However, though the beads 30 are made of the same glass materials, various shapes such as bent shapes, oval shapes and smooth shapes are found on the surface of the beads 30 when they are observed using a scanning electron microscopy. In order that the beads 30 cause less friction with the installation tube, the surface of the beads 30 should be smooth. Thus, heights protruded from the surface of the beads 30, namely roughness, are preferably 10 μm or less. If an optical fiber unit to which beads 30 having a roughness exceeding 10 μm is installed by air pressure, the beads 30 having a rough surface makes friction with the installation tube be increased, thereby deteriorating installation characteristics.

In addition, the beads 30 preferably have spherical shape so as to decrease friction with the installation tube, so a ratio R/r of a long radius R to a short radius r of the beads 30 is preferably in the range of 1 to 1.5. If the ratio R/r of a long radius R to a short radius r of the beads 30 is less than 1 or greater than 1.5, the beads 30 have a rugby ball shape, thereby causing much more friction with the installation tube during the air blown installation in comparison to the case using spherical beads 30.

Hereinafter, air blown installation characteristics of the optical fiber unit to which the spherical beads 30 having a smooth surface are attached according to a preferred embodiment of the present invention is compared with installation characteristics of a conventional optical fiber unit.

### MODE FOR THE INVENTION

### EMBODIMENT

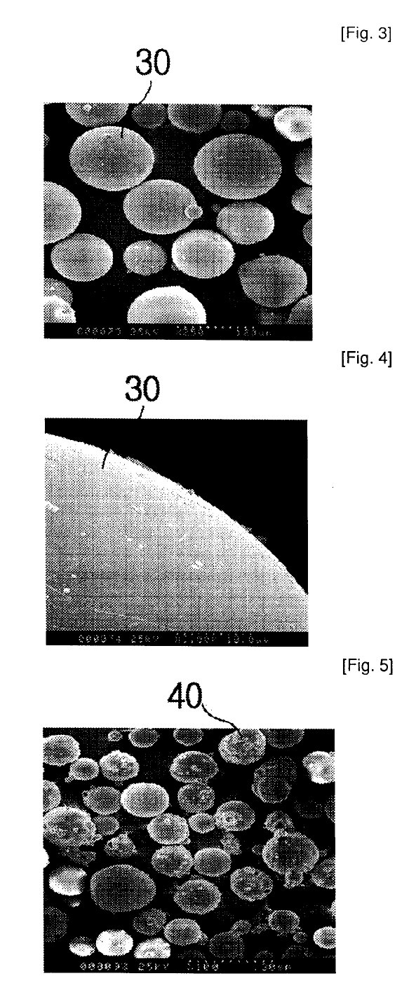

A buffer layer and an outer layer were subsequently formed on the outer circumference of a 4-core single-mode optical fiber by using acrylate that is a radiation curable polymer resin. In order to protect the optical fiber, the outer layer was made of acrylate having higher Young's modulus than the buffer layer. In addition, before the outer layer was cured, glass beads having an average diameter of 80 μm to 140 μm were attached on the surface of the outer layer by using the particle blowing manner. The beads attached were made of glass and had an average roughness of 10 μm or less and a ratio of a long radius to a short radios was in the range of 1 to 1.5. FIG. 3 is a photograph showing the beads employed in the present invention, and FIG. 4 is an enlarged photograph of the beads of FIG. 3. Referring to FIGS. 3 and 4, it will be found that the beads 30 have smooth surface and substantially circular shape. The smooth spherical beads 30 are buried in the outer layer by about 40 μm on the average and protruded out by about 70 μm. As a result of conducting the air blown installation using the optical fiber unit to which the smooth spherical beads are attached according to the present invention, the optical fiber unit was satisfactorily installed to meet 20 mpm to 25 mpm per minute, regulated in the BT (British Telecom) standards, and it was also satisfactorily installed in a curved region with a radius of 3 cm. Meanwhile, when the optical fiber unit according to the present invention was observed by the naked eyes, it was found that the smooth spherical beads attached on the surface of the optical fiber unit were glittering.

### COMPARATIVE EXAMPLE

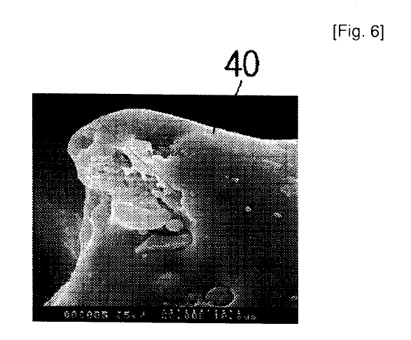

A buffer layer and an outer layer were subsequently formed on the outer circumference of a 4-core single-mode optical fiber by using acrylate that is a radiation curable polymer resin. In order to protect the optical fiber, the outer layer was made of acrylate having higher Young's modulus than the buffer layer. In addition, before the outer layer was cured, glass beads having an average diameter of 80 μm to 140 μm were attached on the surface of the outer layer by using the particle blowing manner. The beads attached were made of glass and had an average roughness of 20 μm or more and a ratio of a long radius to a short radios was 1.5 or above. FIG. 5 is a photograph showing the beads attached on the surface of an optical fiber unit prepared according to the prior art, and FIG. 6 is an enlarged photograph of the beads of FIG. 5. Referring to FIGS. 5 and 6, it will be found that the beads 40 have rough surface or substantially rugby ball shape. The oval spherical beads 40 having a rough surface are buried in the outer layer by about 50 μm on the average and protruded out by about 70 μm. As a result of conducting the air blown installation using the optical fiber unit to which the oval beads with rough surface are attached, the optical fiber unit was not able to give satisfactory installation characteristics according to the BT standards due to friction with the inner surface of the installation tube, and for example an installation rate was abruptly decreased and then occasionally stopped over a range of 50 m. In particular, the installation work was impossible when the installation region was curved.

Meanwhile, when the optical fiber unit according to the prior art was observed by the naked eyes, it was found that the surface of the optical fiber unit was looked misty due to diffused reflection caused by the rough oval beads attached on the surface of the optical fiber unit, and the rough surface was sometimes resulted in generating a scar on a fingernail.

The following Table 1 shows measurement results of the installation characteristics for a linear region and a curved region depending on an average roughness of beads.

As shown in Table 1, it would be understood that, as the average roughness of beads is increased, the installation characteristics are deteriorated, and in particularly the installation work is impossible in the curved region.

TABLE 1

| Roughness (μm) | 0~5 | 5~10 | 10~20 | 20~ |
|---|---|---|---|---|
| Installation | excellent | excellent | good | not good |
| characteristics | | | | |
| in linear region | | | | |
| Installation | excellent | excellent | installation | installation |
| characteristic | | | stopped | impossible |
| in curved region | | | | |

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The optical fiber unit according to the present invention may be easily installed not only in a linear region but also in a curved region since friction with an installation tube is small. In addition, it may be prevented that the surface of a coating layer is damaged due to friction with the installation tube during the installation work.

1. An air blown optical fiber unit, comprising:
at least one optical fiber;
a buffer layer surrounding the optical fiber and made of polymer resin;
an outer layer surrounding the buffer layer and made of polymer resin; and beads attached on a surface of the outer layer,
wherein the beads have an average diameter of 80 μm to 140 μm and an average roughness of 10 μm or less.

2. The air blown optical fiber unit according to claim 1, wherein the beads have a spherical shape in which a radio (R/r) of a long radius (R) to a short radius (r) is in the range of 1 to 1.5.

3. An air blown optical fiber unit, comprising:
at least one optical fiber;
a buffer layer surrounding the optical fiber and made of polymer resin;
an outer layer surrounding the buffer layer and made of polymer resin; and
spherical beads attached on a surface of the outer layer,
wherein the spherical beads have a radio (R/r) of a long radius (R) to a short radius (r) in the range of 1 to 1.5.

4. The air blown optical fiber unit according to any of claims 1 to 3, wherein the beads are made of glass.
